(19) United States
(12) Patent Application Publication
(10) Pub. No.: US 2023/0101178 A1
(43) Pub. Date: Mar. 30, 2023

(54) PLANT AND METHOD FOR TREATING SOLID MATERIAL

(71) Applicant: METSO OUTOTEC FINLAND OY, Tampere (FI)

(72) Inventors: Sebastian LANG, Darmstadt (DE); Roberto VALERY, Oberursel (DE); Peter STURM, Karben (DE); Richard HAAS-WITTMÜSS, Frankfurt (DE); Günter SCHNEIDER, Lorsch (DE); Jan JOLK, Bad Homburg (DE)

(21) Appl. No.: 18/072,759

(22) Filed: Dec. 1, 2022

Related U.S. Application Data
(63) Continuation of application No. PCT/FI2020/050397, filed on Jun. 8, 2020.

(51) Int. Cl. A62D 3/40; C05B 13/02; A62D 3/38; A62D 3/37; F27B 7/36

(52) U.S. Cl. CPC A62D 3/40; C05B 13/02; A62D 3/38; A62D 3/37; F27B 7/362; A62D 2101/43

(57) ABSTRACT

The disclosure relates to a plant for thermal treatment of solid material to decrease the content of heavy metal elements. The plant comprises one reactor for heating the solid material, which is arranged to have both an oxidizing atmosphere and a reducing atmosphere, and the plant includes a hot gas generator, which is arranged to provide hot gas to the reactor. The disclosure also relates to a method for thermal treatment of solid material and to a method for producing fertilizer precursor.

### CROSS-REFERENCE TO RELATED APPLICATIONS

This application is a continuation of PCT International Application No. PCT/FI2020/050397 filed Jun. 8, 2020, the disclosure of this applications is expressly incorporated herein by reference in its entirety.

### TECHNICAL FIELD

The current disclosure relates to a plant and method for thermal treatment of solid material to decrease the content of heavy metal elements.

The disclosure further relates to a method for producing fertilizer precursor, wherein the method utilizes the plant and/or method for thermal treatment of solid material.

### BACKGROUND

Beneficiation of low-grade phosphate ores is a common processing step to achieve a P₂O₅ content of 30% or higher. For siliceous and clays ores, traditional beneficiation techniques (including e.g. crushing, grinding, magnetic separation, flotation, scrubbing and washing) are normally used to remove gangue. However, for ores containing cadmium oxide, carbonates and organic carbon, physical separation methods are not effective.

Several techniques have been investigated for the removal of toxic heavy metal elements, such as cadmium, from phosphate ore. However, they all have drawbacks and it has been difficult to apply the techniques on industrial scale.

For example, calcination under oxidizing atmosphere is not feasible for temperature sensitive phosphate ore as the process temperatures needed to volatilize the cadmium oxide (CdO) are above the critical sintering temperature. This would cause problems in the later processing steps of the ore, such as the leaching step. Also, for example calcination in a fluid bed reactor under reducing atmosphere is not feasible for temperature sensitive phosphate ore as the process temperatures exceed the critical temperature in regard to the formation of accretions.

### PURPOSE

The purpose of the current disclosure is to provide a new type of plant and method for treating solid material to decrease the content of heavy metal elements and other impurities. Especially, for treating low-grade phosphate ore for removing impurities, such as cadmium, carbonates and/or organic carbon.

### SUMMARY

The thermal treatment of solid material, for example low-grade phosphate ores, by the plant and/or method disclosed herein, allows to remove or decrease the content of impurities up to a level to avoid low performance in processes downstream, such as an acidulation process. Also, the thermal treatment enables to comply with quality and health regulations related to the final products, for example fertilizer precursors from which fertilizers can be prepared.

### BRIEF DESCRIPTION OF THE DRAWINGS

The accompanying drawings, which are included to provide a further understanding of the current disclosure and constitute a part of this specification, illustrate embodiments of the disclosure and together with the description help to explain the principles of the current disclosure. In the drawings:

FIG. 1 is a block diagram illustration of one embodiment of the plant.

FIG. 2 is a flowsheet illustration of another embodiment of the plant.

FIG. 3 is a flowsheet illustration of another embodiment of the plant.

### DEFINITIONS

In the present disclosure, the following terms and expressions have the definitions described below, unless otherwise mentioned.

The term “solid material” refers to the feed material to be treated in the plant or according to the method. It may be an ore, such as natural rock and/or sediment, containing valuable material, such as phosphate. The solid material may undergo some sort of treatment before it is used as feed material in the disclosed plant/method. Typically, the ore is a phosphate ore. The phosphate ore can have a phosphate content of less than 30 weight-% based on the total weight of the ore. An ore with an amount of 30 weight-% or less is a low-grade phosphate ore. The solid material is typically granular solid material. Preferably, the solid material is granular solid material with a particle size of 6 mm or less (“fine material”).

The term “hot gas source” is a system for producing hot gas. The hot gas source is typically a hot gas generator that produces hot gas, which can provide heat and a reducing atmosphere and/or oxygen free atmosphere, such as CO and H₂ gas, to the reactor. The hot gas source can be any source that can provide such a gas.

### DETAILED DESCRIPTION

A plant and method according to the current disclosure are provided for thermal treatment of solid material to remove impurities, such as heavy metal species carbonate and/or organic carbon.

An energy efficient solution is provided for thermal treatment of solid material, especially granular solid material, at elevated temperature to decrease the content of toxic heavy metal elements, especially cadmium, and other impurities present in the feed material.

One aim is to provide a new method and plant for directly removing heavy metal species, such as cadmium, from temperature sensitive phosphate ore. Temperature sensitivity is in this regard connected to melt phase formation and respective sintering, yielding to accretions and particle agglomerates above a certain temperature.

Thus, disclosed is a plant for thermal treatment of solid material to decrease the content of heavy metal elements and/or other impurities, which plant comprises:
reactor (5) for heating the solid material to a reaction temperature,
optionally at least one drying system (1,2),
optionally at least one preheating system (3,4),
optionally a heat recovery system (6,7), and
optionally a cooling system (8).

The plant includes only one reactor (5), and the reactor is arranged to have both an oxidizing atmosphere and a reducing atmosphere. In addition, the plant includes a hot gas source (9), which is arranged to provide hot gas to the reactor (5).

Disclosed is also a method for thermal treatment of solid material to remove heavy metal elements and/or other impurities, wherein the method comprises the following steps:
heating the solid material in a reactor to a reaction temperature to decrease the content of heavy metal elements and/or other impurities,
optionally drying the solid material,
optionally preheating the solid material,
optionally cooling the heated solid material, and
obtaining treated solid material.

In the method, the heating is performed in only one reactor, and the reactor has both a reducing atmosphere and an oxidizing atmosphere. The heating of the reactor is at least partly achieved by providing hot gas via a hot gas source.

The plant and/or method enable energy efficient removal of impurities from the solid material, such as heavy metals and/or carbonate species. Local high temperatures are avoided, since the plant is not operated by direct combustion only.

According to one embodiment, the plant and/or method can provide a calcine product (i.e. treated solid material) containing phosphate (P₂O₅) with a content of 60 mg/kg or less of cadmium (Cd) per P₂O₅ equivalent. It is possible to remove at least 50 weight-%, or even up to 70 or 80 weight-% of the Cd from the feed material i.e. the solid material.

According to one preferred embodiment, the reactor is a rotary kiln. A rotary kiln has several advantages. One important advantage is that it provides free-board in the top part of the kiln, where the gas can flow counter-current, enabling the two different atmospheres due to its elongated form. Typically, the rotary kiln includes a spillage chute (5′), from which spillage (5d) can be removed.

A rotary kiln is preferred, but other reactor alternatives could be a rotary hearth furnace, a shaft furnace, or a fluidized bed reactor.

The effect of having an oxidizing and a reducing atmosphere in same reactor is that the impurities to be removed such as CdO can be reduced to metallic Cd, but instant re-oxidation of the Cd can be avoided. Instead, re-oxidizing happens in the free-board near the gas exit (such as the feed-end at top part of the rotary kiln) to allow CdO to exit the kiln, for example by sticking to solid particles, such as dust exiting the reactor. Thus, the impurity is removed efficiently.

According to one preferred embodiment, the hot gas source (9) is arranged to provide hot reducing gas for heating and for providing a reducing atmosphere.

According to one preferred embodiment, the hot gas source (9) is a hot gas generator. One advantage with the hot gas generator is that it can provide the reducing atmosphere in addition to providing heat in the form of hot gas. This gives energy efficiency and enables control of process conditions, such as suitable reaction temperature and low oxygen partial pressure.

All optional parts mentioned above are beneficial for energy efficiency by providing means for heat recovery etc. Typically, a low-grade ore is used as raw material in the plant, and in that case energy efficiency is very important to enable a cost effective and industrially usable plant.

According to one embodiment, the plant comprises a preheating system (3,4). The preheating system preferably comprises at least one preheater (3). The preheater includes a venturi and a cyclone for separating gas and solids.

According to one embodiment, the plant comprises a drying system (1,2). The drying system comprises preferably at least one dryer (1). According to one embodiment, the plant comprises at least one pre-dryer (1). One purpose of the pre-dryer is to remove surface moisture from the solid material used as feed material.

According to one preferred embodiment, the plant includes a pre-dryer (1) and downstream to the pre-dryer (1), a preheater (3). After the preheater, the solid material is fed to the reactor (5). The preheater and pre-dryer combination gives an advantage, since using a pre-dryer can prevent the impurities, such as Cd particles, from attaching to the preheater, which would cause difficulties in the processability of the solid material. This can be a problem in particular if the solid material contains moisture. Also, the combination of pre-dryer and preheater further improves energy efficiency.

Accordingly, according to one embodiment of the method, the solid material is dried in a pre-dryer (1) and subsequently heated in a preheater (3). After heating in the preheater, the 5 solid material is fed to the reactor (5).

According to one embodiment, the plant comprises a heat recovery system (6,7).

According to one embodiment, the plant comprises a cooling system (8).

According to one embodiment, the solid material is an ore. Typically, the ore is a phosphate ore. The phosphate ore can have a phosphate content of less than 30 weight-% based on the total weight of the ore. An ore with an amount of 30 weight-% or less is a low-grade phosphate ore.

According to one embodiment, the reactor (5) is a rotary kiln, and the hot gas source is arranged to heat the solid material and provide reducing gas by counter-current gas flow.

According to one embodiment of the method, the solid material is heated in a counter-current flow.

The counter-current flow ensures that the heat and optionally reducing atmosphere are provided to the right location in the kiln. This improves the efficiency in the reactions that take place in the kiln.

According to one embodiment, the hot gas source (9) is arranged to provide hot gas into the reactor at and/or near its discharge end (5-2). Preferably, the hot gas contains reducing species, such as hot gas comprising CO and H₂ gas.

According to one embodiment of the method, the heating of the reactor is at least partly achieved by providing hot gas comprising CO and H₂ via a hot gas source at and/or near the discharge end (5-2) of the reactor (5).

The CO and H₂ gases provide the reducing atmosphere. Introducing them at and/or near the discharge end of the kiln, provides the reducing atmosphere in the most optimal location of the kiln.

According to one embodiment, the reducing atmosphere is arranged at and/or near the discharge end (5-2) of the reactor (5) and the oxidizing atmosphere is arranged at and/or near the feed end (5-1) of the reactor (5). This arrangement gives the atmospheres for reactions in the most optimal location, enabling the desired reactions.

According to one embodiment, the reactor (5) is a rotary kiln, which comprises at least two shell air fans (5b). The shell air fans have the effect of providing air/oxygen into the kiln. Air can combust CO and H₂ gas, which can be provided by the hot gas source (9), in return providing an oxidizing atmosphere in the free-board of the kiln. This enables oxidizing Cd back to CdO, which typically sticks to solid particles such as ash or dust and leaves the kiln with the off-gas. The solid particles can be removed from the gas via a cyclone.

According to one preferred embodiment, the reactor (5) is a rotary kiln, which comprises at least one shell air fan (5b) per every 10 meter kiln. This frequency of shell air fans may provide enough air to enable the desired reactions.

According to one embodiment, the heavy metal elements include cadmium (Cd).

According to one embodiment, the reactor is arranged to heat the solid material to a reaction temperature of 500 to 1000° C., preferably 750 to 900° C.

According to one embodiment of the method, the solid material in the reactor is heated to a reaction temperature of 700 to 1000° C., preferably 750 to 900° C.

The above-mentioned reaction temperatures are preferred at least in case cadmium in the form of cadmium oxide is removed from the solid material, since the temperature is high enough to volatilize metallic Cd, but not too high to give unwanted side reaction.

The temperature of the hot gas providing the heat may be higher, such as 1200° C. According to one embodiment, the plant includes at least one preheater (3) and the off-gas exiting the reactor (5) (such as the rotary kiln) is arranged to be led to the at least one preheater (3). Leading the off-gas to a preheater enables energy recovery. Further, the gas can be cleaned and recirculated to the hot gas source. Thus, the preheater can be used as heat recovery system to make the plant and method more efficient. This sort of integrated process is an efficient way to recover heat, thus keeping operating costs as low as possible (by heat recovery). It could also be possible to heat other materials, for example water, to produce steam to provide the preheating.

According to one embodiment, removing the heavy metal elements from the heating step is done by attaching the elements to solid particles suspended in the off-gas flow from the reactor. This way the particles will not contaminate the feed material i.e. the solid material. According to one embodiment, the solid material used in the disclosed method is granular solid material. Preferably, the granular solid material is fine material, having a particle size of 6 mm or less.

Further, the invention discloses a method for producing fertilizer precursor, wherein 5 the method utilizes the plant according to any one of the embodiments described herein and/or the method according to anyone of the embodiments described herein.

The figures illustrate some specific embodiments of the plant according to this disclosure.

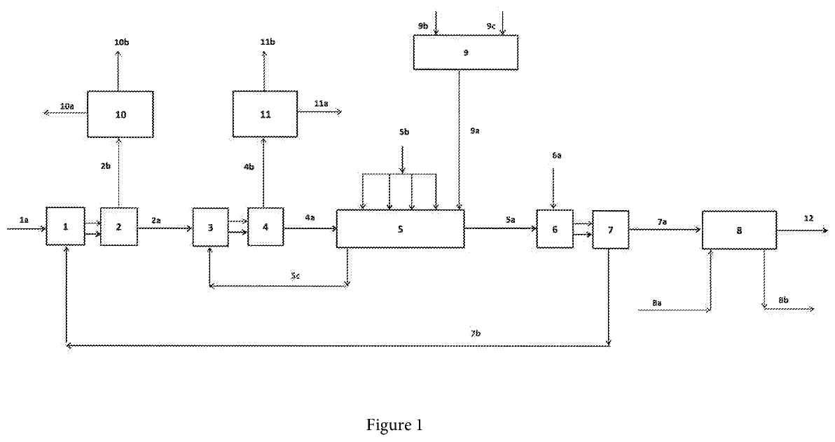

FIG. 1 is a block diagram showing a plant according to one embodiment. It includes a drying system (dryer 1 for drying the solid material, and dryer cyclone 2), a preheating system (preheater 3, and preheater cyclone 4), a reactor 5 (rotary kiln), a heat recovery system (heat recovery 6, and cyclone 7), a cooling system (cooler 8, and cooling water inlet line 8a and return water outlet line 8b), and a hot gas source 9. FIG. 1 also shows an inlet line 1a for feeding the solid material, and an outlet line 12 for discharging the treated solid material (calcine product). Dusty gas is removed from the dryer cyclone 2 by a line 2b and fed to the dedusting system 10. Dried solid material is fed from the drying system to the preheater 3 via a line 2a. Therein, dust and off-gas are separated and led out via a line 10a and a line 10b, respectively. Gas (line 4b) from the preheater cyclone 4 is fed to a gas cleaning system 11 and dust 11a and off-gas 11b are separated. The preheated solid material is fed to the reactor 5 via a line 4a. Shell air fans 5b provide air and/or oxygen to the reactor 5. Fuel (line 9b) (for example pet-coke) and air (line 9c) are led to the hot gas source 9 (typically a hot gas generator), and hot gas is fed to the reactor via a line 9a close to its discharge end of the reactor 5. Kiln off-gas is recycled back from the reactor 5 to the preheater 3 via a line 5c. The solid material treated in the reactor 5 (reactor discharge) is led to the heat recovery 6 via a line 5a. The heat recovery 6 is provided with cooling air via a line 6a. Preheated air is led from the cyclone 7 to the dryer 1 via a line 7b. The solid material (hot calcine) is further led to the cooler 8 via a line 7a. Therein, cooling water is led into the cooler 8 via a line 8a and return water is led out via a line 8b. The treated solid material (calcine product) is led out from the cooler via the line 12.

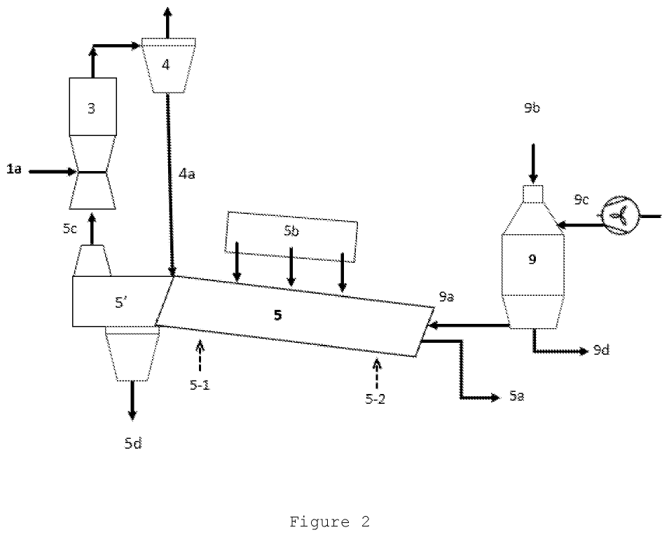

FIG. 2 shows a plant according to one embodiment of this disclosure. It includes a preheating system (preheater 3, and preheater cyclone 4), a reactor 5 (rotary kiln calciner), and a hot gas source 9 (hot gas generator). FIG. 2 also shows an inlet line 1a for feeding the solid material into the preheating system. The preheated solid material is fed to the reactor 5 via a line 4a. Shell air fans 5b provide air and/or oxygen to the reactor 5. The reactor has a discharge end 5-2 and a feed end 5-1. Fuel, line 9b (for example pet-coke), and air, line 9c, are led to the hot gas source 9, and hot gas is fed to the reactor via a line 9a close to the discharge end 5-1 of the reactor 5. The reactor system includes a spillage chute 5′ and spillage is led out via a line 5d. Kiln off-gas is recycled back from the reactor 5 to the preheater 3 via a line 5c.

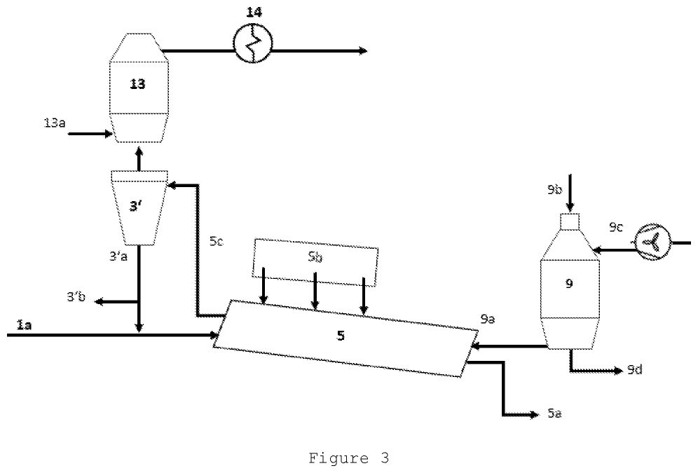

FIG. 3 shows a plant according to another embodiment of this disclosure. It includes a separator 3′, a reactor 5 (rotary kiln calciner), a hot gas source 9 (hot gas generator), and an after burning chamber 13 and a heat recovery 14 after the after burning chamber. FIG. 3 also shows an inlet line 1a for feeding the solid material into the reactor 5. Coarse dust is led out from the separator 3′ via a line 3′a to line 1a and dust bleed 3′b is led out. Shell air fans 5b provide air and/or oxygen to the reactor 5. Fuel, line 9b, and air, line 9c, are led to the hot gas source 9, and hot gas is fed to the reactor via a line 9a close to the discharge end of the reactor 5. The after burning chamber is provided with air via a line 13a.

The disclosure provides a plant and a method to directly and energy efficiently remove cadmium from temperature sensitive low-grade phosphate ore. It has been shown in tests performed in connection with the present invention that a high rate of removal can be achieved (Example 1).

In the following one very specific embodiment of the plant and method of this disclosure is described, where the solid material is low-grade phosphate ore containing cadmium oxide and other impurities, which are to be removed with the plant and method according to this disclosure.

Whenever the feed ore contains cadmium oxide as a metal trace element, relatively high temperature (above 1000° C.) are needed to volatilize the cadmium oxide due to its low vapor pressure. For some (temperature sensitive) phosphate ores there is a temperature limit at around 800° C. to 900° C. before accretion and agglomerate formation starts. These side-effects would give unacceptable consequences in an industrial process; for example malfunction of equipment and blockages, which could lead to shut-down.

To remove cadmium and omit prohibitive high temperatures with the unwanted consequences of sticky material behavior, the cadmium oxide is reduced into its metallic form to get liberated from the solid. Cadmium as an element of metal has a substantially higher vapor pressure than its oxidic state and can be volatilized already at temperatures above 500° C. The heterogenous conversion reaction of cadmium oxide to metallic cadmium necessitates relatively mild reducing conditions regarding the surrounding gas atmosphere and temperatures above 500° C. Gaseous reducing agent CO (carbon monoxide) can be used.

To prevent instantaneous re-oxidation and respective resublimation of permeating cadmium fume within the boundary layer of the solid bed in a reactor, a sufficiently low (close to zero) oxygen partial pressure has to be adjusted in the kiln free-board at or near the discharge end of the reactor. This is achieved via a hot gas source, such as a hot gas generator, upstream the reactor, which is operated under or very close to sub-stoichiometric conditions to deplete the hot gas from oxygen present.

A post combustion of fuel components present in the hot gas is arranged in the middle/front part of the reactor (at and/or near the feed-end), where the metallic cadmium in the free-board gets re-oxidized as well. After re-oxidation, the cadmium oxide immediately re-sublimated on solid surfaces present like e.g. on dust particles or the kiln wall. The cadmium oxide gets finally removed from the kiln in the solid state attached to dust particles, suspended in the hot off-gas flow from the reactor (at its feed-end).

Additional systems can be used to recover heat from the hot off-gas and hot calcined product from the rotary kiln to significantly decrease fuel consumption.

In the following chapter, the steps of the method and parts of the plant in this one very specific embodiment are described more closely.

Moist solid material (for example filter cake) is fed to a venturi pre-dryer. The predrying step has the task to remove surface moisture from the ore particles and prevent the cadmium/impurities containing dust from binding to the fresh material via wet agglomeration in the subsequent pre-heater, which is operated with hot kiln off-gas. The second task of the pre-dryer is to screen out ultra-fine material from the feed ore, which gets downstream collected via a de-dusting system. This dust is not Cd enriched.

Re-condensation of the pre-dryer off-gas is avoided by a by-pass mixing hot fresh air with the off-gas before entering the cyclone and de-dusting unit.

The pre-dried material is transported to a venturi pre-heater, here the solid feed material gets further dried and heated up in direct heat exchange with the hot reactor off-gas.

The preheated material can then be fed into the reactor via a special feeding pipe to prevent dust formation. In case of the requirement of additional reducing agent, very low amounts 5 of carbonaceous material can be fed to the kiln as well.

The counter-current operation of the kiln and shell air fans allow to adjust for special atmospheric conditions along the kiln's length. The use of a hot gas source (hot gas generator) will allow to deliver hot reducing gas to the kiln at a controlled temperature avoiding any local overheating of the calicne typically found in standard kilns with a central burner. The hot calcine leaving the kiln can be screened to remove any lumpy particles before being fed into a two-staged venturi cooling system used for air-preheating. Preheated air from the two-staged venturi cooling system is then used for drying the solid material. Before the treated solid material (calcine) can be discharged onto a conveyor belt it has to be cooled down to the final target temperature in a product-cooler.

According to another embodiment, the drying of the solid material is performed in a separate unit and the dry solid material is fed in the venturi pre-heater or directly into the reactor. The hot calcine discharged from the rotary kiln can be directly cooled down in a product cooler.

One important advantage that can be achieved if treating phosphate ore, is that thermal treatment and respective decomposition (calcination) of carbonates and bound water contained in the phosphate ore facilitates the downstream leaching process and minimizes the acid (e.g. sulphuric acid) demand for the phosphoric acid production. Phosphoric acid is the base material for phosphate fertilizer production, which is one possible use of phosphate treated by the present method and plant.

Several important advantages can be achieved with the plant and methods described herein.

The embodiments described hereinbefore may be used in any combination with each other. Several of the embodiments may be combined to form a further embodiment. A plant or method, to which the disclosure is related, may comprise at least one of the embodiments described hereinbefore.

### EXAMPLES

Reference will now be made in detail to the embodiments of the present disclosure, an example of which is illustrated in the accompanying drawing.

The description below discloses some embodiments in such a detail that a person skilled in the art is able to utilize the method and plant based on the disclosure. Not all steps of the embodiments are discussed in detail, as many of the steps will be obvious for the person skilled in the art based on this specification.

For reasons of simplicity, item numbers will be maintained in the following exemplary embodiments in the case of repeating components.

FIG. 1 illustrates a plant according to one embodiment by a block diagram.

### Example 1—Pilot Scale Rotary Kiln Test: Calcination of Low-Grade Phosphate Ore

The target of the process was to upgrade phosphate ore by removing moisture, volatiles, organic carbon and Cadmium.

Low-grade ore containing 28.5% of P₂O₅ and 12% moisture was fed to a drying system (1,2), where moisture was removed by direct contact of the ore with hot air, which was preheated in the heat recovery system (6,7).

The dry ore and air were separated via a cyclone (2) and dusty air (2b) was sent to a dedusting system (10) for removing dust before it was released to the atmosphere (10a dust, 10b off-gas). The dust can be disposed or mixed with the final product.

The dry ore from the cyclone (2) was transferred to the preheater (3), where it was 5 preheated to temperatures >250° C. with hot off-gas (5c) coming from the rotary kiln calciner (5).

Gas and preheated solids were separated in the preheater cyclone (4). The dusty gas was sent to a gas cleaning system (11) for removing cadmium containing dust and any other contaminant, before it was released to the atmosphere (11a dust, 11b off-gas).

The preheated ore was transferred from the preheater cyclone (4) to the rotary kiln (5) (line 4a). In the rotary kiln the ore was heated up in counter-current with hot gas flowing through the kiln free-board.

Following the flow direction of the gases, the atmosphere in the kiln was changing from reducing atmosphere (close to the discharge end of the kiln) to oxidizing atmosphere (close to the feed-end of the kiln) via addition of air along the kiln (shell air fans 5b). Reducing gas was continuously combusted by air providing heat.

In the kiln organic carbon contained in the ore was burned and volatiles were removed. The cadmium oxide (CdO) contained in the ore was removed in the reducing atmosphere to metallic cadmium and thereby it was transferred to the gas phase. As soon as the atmosphere in the kiln changed to an oxidizing atmosphere (when the gas flowed towards the feed-end), the cadmium metal (vapor) was oxidized to cadmium oxide (solid) and finally entrained as dust with the kiln off-gas.

Hot calcine from the kiln was discharged to a heat recovery system (6), where the solids were cooled down directly in contact with air. Air and solids were separated via a cyclone (7).

Solids from the cyclone (7) were transferred to a cooler where it was cooled down indirectly with water. The preheated air from the cyclone (7) was used for drying the feed material in the dryer (1).

By using this process and plant, calcination degrees above 90% and cadmium removal above 80% could be achieved. For example, the P₂O₅ content was increased to 31.7% and Cd content was decreased from 30 mg/kg to 6 mg/kg.

It is obvious to a person skilled in the art that with the advancement of technology, the basic idea of the invention may be implemented in various ways. The invention and its embodiments are thus not limited to the examples described above; instead they may vary within the scope of the claims.

1. A plant for thermal treatment of solid material to decrease the content of heavy metal elements and/or other impurities, which plant comprises
optionally at least one drying system (1,2),
optionally at least one preheating system (3,4),
a reactor (5) for heating the solid material to a reaction temperature,
optionally a heat recovery system (6,7), and
optionally a cooling system (8)
characterized in that said plant includes only one reactor (5), and that said reactor (5) is arranged to have both an oxidizing atmosphere and a reducing atmosphere, and that the plant includes a hot gas source (9), which is arranged to provide hot gas to the reactor, wherein the reactor (5) is a rotary kiln, wherein the hot gas source is arranged to heat the solid material and provide reducing gas by counter current gas flow.

2. The plant according to claim 1, wherein the hot gas source (9) is arranged to provide hot reducing and/or oxygen free gas for heating and providing a reducing atmosphere.

3. The plant according to any one of the preceding claims, wherein the hot gas source (9) is a hot gas generator.

4. The plant according to any one of the preceding claims, wherein the solid material is an ore, preferably a phosphate ore, preferably a phosphate ore having a phosphate content of less than 30 weight-%.

5. The plant according to any one of the preceding claims, wherein the hot gas source (9) is arranged to provide hot gas, preferably hot gas comprising CO and H₂, into the reactor (5) at and/or near its discharge end (5-2).

6. The plant according to any one of the preceding claims, wherein the reducing atmosphere is arranged at and/or near the discharge end (5-2) of the reactor (5) and the oxidizing atmosphere is arranged at and/or near the feed-end (5-1) of the reactor (5).

7. The plant according to any one of the preceding claims, wherein the reactor (5) is a rotary kiln, which comprises at least two shell air fans (5b).

8. The plant according to any one of the preceding claims, wherein the reactor (5) is a rotary kiln, which comprises at least one shell air fan (5b) per every 10 meter kiln.

9. The plant according to any one of the preceding claims, wherein the reactor (5) is arranged to heat the solid material to a temperature of 500 to 1000° C., preferably 750 to 900° C.

10. The plant according to any one of the preceding claims, wherein the heavy metal elements include cadmium (Cd).

11. The plant according to any one of the preceding claims, wherein the plant includes at least one preheater (3) and the off-gas (5c) exiting the rotary kiln is arranged to be led to said at least one preheater (3).

12. The plant according to any one of the preceding claims, wherein the plant includes a pre-dryer (1) and downstream to the pre-dryer (1), a preheater (3).

13. A method for thermal treatment of solid material to remove heavy metal elements and/or other impurities, wherein the method comprises the following steps
optionally drying the solid material,
optionally preheating the solid material,
heating the solid material in a reactor to a reaction temperature to decrease the content of heavy metal elements and/or other impurities,
optionally cooling the heated solid material, and
obtaining treated solid material
characterized in that the heating is performed in only one reactor, and that said reactor has both a reducing atmosphere and an oxidizing atmosphere, and that heating of the reactor is at least partly achieved by providing hot gas via a hot gas source, wherein the reactor (5) is a rotary kiln, wherein the solid material is heated in a counter-current flow.

14. The method according to claim 13, wherein the solid material is an ore, preferably a phosphate ore, preferably having a phosphate content of less than 30 weight-%.

15. The method according to claim 13, or 14, wherein the hot gas source is a hot gas generator.

16. The method according to any one of the claims 13 to 15, wherein heating of the reactor is at least partly achieved by providing hot gas comprising CO and H₂ via a hot gas source at and/or near the discharge end of the reactor.

17. The method according to any one of the claims 13 to 16, wherein removing the heavy metal elements from the heating step is done by attaching the elements to solid particles suspended in the off-gas flow.

18. The method according to any one of the claims 13 to 17, wherein the reactor is a rotary kiln, which comprises at least two shell air fans.

19. The method according to any one of the claims 13 to 18, wherein the reactor is a rotary kiln, which comprises at least 1 shell air fan per 10 meter kiln.

20. The method according to any one of the claims 13 to 19, wherein the solid material in the rotary kiln is heated to a temperature of 700 to 1000° C., preferably 750 to 900° C.

21. The method according to any one of the claims 13 to 20, wherein the heavy metal elements include cadmium (Cd).

22. The method according to any one of the claims 13 to 21, wherein the solid material is granular solid material, preferably having a particle size of 6 mm or less.

23. The method according to any one of the claims 13 to 22, wherein the solid material is dried in a pre-dryer and subsequently heated in a preheater before said solid material is fed to the reactor.

24. A method for producing fertilizer precursor, characterized in that the method utilizes the plant according to any one of the claims 1 to 12 and/or the method according to anyone of the claims 13 to 23.
